(19) United States
(12) Patent Application Publication
(10) Pub. No.: US 2005/0068122 A1
(43) Pub. Date: Mar. 31, 2005

(54) Garnet ferrite having a small absolute value of temperature coefficient of 4piMs and a small ferromagnetic resonance half-width, and a non-reciprocal circuit element applying the same

(75) Inventor: Kinshiro Takadete, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/945,787

(22) Filed: Sep. 21, 2004

(30) Foreign Application Priority Data
Sep. 25, 2003 (JP) 2003-333386

(51) Int. Cl. H01P 1/36

(52) U.S. Cl. 333/24.2; 333/1.1

(57) ABSTRACT

A garnet ferrite for a non-reciprocal circuit element expressed by the formula Y₃₋ₓGdₓFe_{t-2y-z}Co_{y}Si_{y}Al_{z}O₁₂ (where 0.2≦x≦1.5, 0.005≦y≦0.015, 0≦z≦1.5, 4.75≦t≦5) is provided. The absolute temperature coefficient αof 4πMs and the ferromagnetic resonance half-width ΔH are low. In addition, an isolator is provided, wherein the isolator includes a magnetic assembly made up of a main body (the garnet ferrite element) and a plurality of center conductors disposed on the upper surface of the main body so that each of the center conductors intersect at a predetermined angle while being electrically insulated from each other, a magnet for applying a direct current magnetic field to the magnetic assembly, matching capacitors, and a yoke (upper and lower cases) for holding all the components. Loss is low in a high-frequency band, such as the microwave band.

### BACKGROUND OF THE INVENTION

1. Field of the Invention

The present invention relates to a garnet ferrite used for a non-reciprocal circuit element used in a high-frequency band, such as the microwave band, and the non-reciprocal circuit element. In particular, the invention relates to the technology for reducing the absolute temperature coefficient α of 4πMs and for reducing the ferromagnetic resonance half-width of the garnet ferrite.

2. Description of the Related Art

Known high-frequency magnetic materials include MnZn ferrite, NiZn ferrite, lithium ferrite, and YIG ferrite. A non-reciprocal circuit element including a high-frequency magnetic material used as a non-reciprocal element is disposed between an antenna and an amplifier of a radio communication apparatus, such as a cellular phone, to maintain operational stability and to prevent cross modulation.

Among the above-mentioned magnetic materials, YIG ferrite is obtained by replacing part of the elements of Y₃Fe₅O₁₂ with gadolinium or aluminum, and some known YIG ferrites exhibit a low loss.

Unfortunately, any change in the ambient temperature causes a change in the isolation characteristic of YIG ferrite. Thus, a YIG ferrite having a small absolute temperature coefficient a of 4πMs is desired.

A known magnetic material having a small absolute temperature coefficient a may be a garnet ferrite including 0.5% to 5% less iron in comparison with the stoichiometric ratio. This garnet ferrite may be used for a non-reciprocal circuit element and can be expressed by the formula A₃B₅O₁₂ (where A represents yttrium, or yttrium and gadolinium, and B represents iron, or iron and at least one of aluminum, indium, and manganese) (for example, refer to U.S. Patent No. 2003/0080315) or the formula Y_{3-3x-z}Gd₃ₓCa_{z}Fe_{5-5y-z-5e}Al_{5y}Sn_{z}O₁₂ (where 1.5<3x<2.4, 0<y<0.12, 0<z<0.4, and e has a value close to 0 and is provided for the purpose of maintaining the stoichiometric balance) (for example, refer to U.S. Pat. No. 3,886,077). This known garnet ferrite may be used for a circuit element, such as an isolator or a circulator.

This garnet ferrite having a small absolute temperature coefficient a is often used in non-reciprocal circuit elements having a reduced-size.

The absolute temperature coefficient a of a known garnet ferrite expressed by the above-mentioned formulas A₃B₅O₁₂ or Y_{3-3x-z}Gd₃ₓCa_{z}Fe_{5-5y-z-5e}Al_{5y}Sn_{z}O₁₂ is reduced as the amount of gadolinium added to the composition is increased. When the amount of added gadolinium is increased, however, there is a problem in that the ferromagnetic resonance half-width ΔH increases and the loss of an isolator used in a high-frequency band such as the microwave band increases. For example, for a garnet ferrite expressed by the formula A₃B₅O₁₂, the temperature coefficient α at −35° C. is reduced to close to 0 when the composition ratio of gadolinium exceeds 1.5 but the ferromagnetic resonance half-width ΔH exceeds 10,000 A·m⁻¹.

The temperature coefficient α of a garnet ferrite expressed by the formula Y_{3-3x-z}Gd₃ₓCa_{z}Fe_{5-5y-z-5e}Al_{5y}Sn_{z}O₁₂, whose composition ratio of gadolinium is 1.5 to 2.4, is a positive value. In particular, when the gadolinium ratio is 2.0 or more, the temperature coefficient α exceeds 0.5%·° C.⁻¹. On the other hand, the temperature coefficient for the surface flux of a permanent magnet used for a non-reciprocal circuit element such as an isolator is often a negative value. Therefore, the slope of the temperature coefficient for the garnet ferrite and the permanent magnet are in an inverse relationship. Hence, the characteristics of the non-reciprocal circuit element change more significantly in response to a temperature change compared to those of the permanent magnet.

### SUMMARY OF THE INVENTION

The present invention has taken into consideration the above-mentioned problems to achieve an object to provide a garnet ferrite having a small absolute temperature coefficient α of 4πMs and a low ferromagnetic resonance half-width ΔH.

Another object of the present invention is to provide a non-reciprocal circuit element having a low loss in a high-frequency band such as the microwave band.

To achieve the above-mentioned objects, the garnet ferrite according to the present invention is prepared in the composition described below.

An example of a garnet ferrite for a non-reciprocal circuit element according to the present invention is expressed by the formula Y₃₋ₓGdₓFe_{t-2y-z}Co_{y}Si_{y}Al_{z}O₁₂ (where 0.2≦x≦1.5, 0.005≦y≦0.015, 0≦z≦1.5, and 4.75≦t≦5).

Adding copper and silicon in accordance with the above-mentioned composition ratio to the garnet ferrite (having a composition of Y—Gd—Fe—Al—O) reduces the ferromagnetic resonance half-width ΔH compared to garnet ferrite with only gadolinium added. Moreover, adding gadolinium within the above-mentioned range reduces the absolute temperature coefficient α of 4πMs.

By changing the amount of aluminum added within the above-mentioned range, the value of the 4πMs can be adjusted. By adjusting the sum of the amounts of iron, copper, silicon, and aluminum, a single-phase of garnet not including any precipitation of a hetero-phase is obtained. Thus, the ferromagnetic resonance half-width ΔH is reduced.

The garnet ferrite for a non-reciprocal circuit element according to the present invention has a small absolute temperature coefficient α of 4πMs and a low ferromagnetic resonance half-width ΔH. The garnet ferrite according to the present invention has a low ferromagnetic resonance half-width ΔH compared to a known garnet ferrite when the temperature coefficient α is the same as that for the known garnet ferrite.

Thus, the garnet ferrite according to the present invention contributes to reducing the loss of a non-reciprocal circuit element.

Another example of a garnet ferrite for a non-reciprocal circuit element according to the present invention is expressed by the formula Y₃₋ₓ₋ᵤGdₓCaᵤFe_{t-2y-u-z}Co_{y}Si_{y}DᵤAl_{z}O₁₂ (where D represents at least one of zirconium, hafnium, and tin, and 0.2≦x≦1.5, 0.005≦y≦0.015, 0≦z≦1.5, 4.75≦t≦5, and 0<u≦0.3).

Since copper, silicon, calcium, and D are added to the garnet ferrite according to this example at the above-mentioned composition ratio, the garnet ferrite has a low ferromagnetic resonance half-width ΔH compared to garnet ferrite only having gadolinium added (i.e., a garnet ferrite having a composition of Y_Gd_Fe_Al_O).

Another example of a garnet ferrite for a non-reciprocal circuit element according to the present invention is expressed by the formula Y₃₋ₓGdₓCaᵤFe_{t-2y-v-z}Co_{y}Si_{y}InᵥAl_{z}O₁₂ (where 0.2≦x≦1.5, 0.005≦y≦0.015, 0 5≦z≦1.5, 4.75≦t≦5, and 0<v≦0.2).

Since copper, silicon, and indium are added to the garnet ferrite according to this example at the above-mentioned composition ratio, the garnet ferrite has a low ferromagnetic resonance half-width ΔH compared to garnet ferrite only having gadolinium added (i.e., garnet ferrite having a composition of Y—Gd—Fe—Al—O).

The x, y, z, and t of the above-mentioned example of garnet ferrite for a non-reciprocal circuit element expressed by the formula Y₃₋ₓGdₓFe_{t-2y-z}Co_{y}Si_{y}Al_{z}O₁₂are preferably in the ranges of 0.2≦x≦1.25, 0.005≦y≦0.01, 0≦z≦1.5, and 4.75≦t≦4.9.

The x, y, z, t, and u of the above-mentioned example of garnet ferrite for a non-reciprocal circuit element expressed by the formula Y₃₋ₓ₋ᵤGdₓCaᵤFe_{t-2y-u-z}Co_{y}Si_{y}DᵤAl_{z}O₁₂ are preferably in the ranges of 0.2≦x≦1.25, 0.005≦y≦0.01, 0≦z≦1.5, 4.75≦t≦4.9, and 0.04≦u≦0.2.

The x, y, z, t, and v of the above-mentioned example of garnet ferrite for a non-reciprocal circuit element expressed by the formula Y₃₋ₓGdₓFe_{t-2y-v-z}Co_{y}Si_{y}InᵥAl_{z}O₁₂ are preferably in the ranges of 0.2≦x≦1.25, 0.005≦y≦0.01, 0≦z≦1.5, 4.75≦t≦4.9, and 0.04≦v≦0.2.

The non-reciprocal circuit element according to the present invention includes a magnetic assembly made up of a main body (a garnet ferrite according to one of the above-mentioned examples) and a plurality of center conductors disposed on the main body so that the center conductors intersect each other while being electrically insulated from each other. A non-reciprocal circuit element such as an isolator may be prepared by using the magnet assembly.

An embodiment of the non-reciprocal circuit element according to the present invention includes a magnetic assembly, a magnet for applying a direct current magnetic field to the magnetic assembly, matching capacitors, and a yoke for containing all the components. The magnetic assembly includes a main body (a garnet ferrite according to one of the above-mentioned examples) and a plurality of center conductors disposed on the upper surface of the main body so that the center conductors intersect each other at a predetermined angle while being electrically insulated from each other. A non-reciprocal circuit element such as an isolator may have the above-mentioned structure.

The non-reciprocal circuit element having the above-mentioned structure has a small absolute temperature coefficient α of 4πMs. Moreover, since a magnetic assembly having a main body composed of a garnet ferrite with a low ferromagnetic resonance half-width ΔH has been included in the non-reciprocal circuit element, the loss is reduced in a high-frequency band such as the microwave band. Thus, a non-reciprocal circuit element, whose characteristics are less affected by temperature, is provided.

The garnet ferrite according to the present invention has a small absolute temperature coefficient α of 4πMs and has a low ferromagnetic resonance half-width ΔH.

The non-reciprocal circuit element according to the present invention includes a magnetic assembly including a garnet ferrite according to the present invention that has a small absolute temperature coefficient α of 4πMs and a low ferromagnetic resonance half-width ΔH, a magnet, matching capacitors, and a yoke. Thus, a non-reciprocal circuit element, whose loss is reduced in a high-frequency band such as the microwave band and whose characteristics are less affected by temperature, is provided.

### BRIEF DESCRIPTION OF THE DRAWINGS

FIG. 1 is an exploded perspective diagram illustrating an isolator including a garnet ferrite according to the present invention;

FIG. 2 illustrates the relationship between the temperature coefficient α(−35) and the ferromagnetic resonance half-width ΔH of a sample of a known garnet ferrite and a garnet ferrite according to the present invention; and

FIG. 3 illustrates the relationship between the temperature coefficient α(85) and the ferromagnetic resonance half-width ΔH of a sample of a known garnet ferrite and the garnet ferrite according to the present invention.

### DESCRIPTION OF THE PREFERRED EMBODIMENT

Examples of the present invention will now be described by referring to the drawings. In the drawings, the proportions of the components may be changed compared to the actual proportions in order to make the drawings easily viewable.

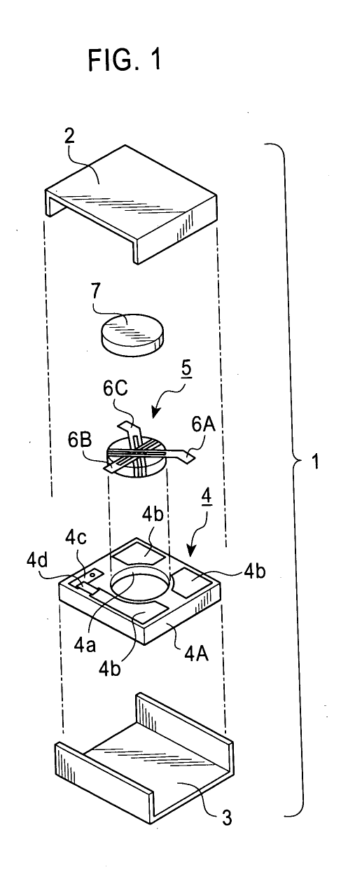

FIG. 1 is an exploded perspective diagram illustrating an isolator (non-reciprocal circuit element) including a garnet ferrite for a non-reciprocal circuit element according to the present invention. An isolator 1 includes an upper case 2 and a lower case 3. Between the upper and lower cases 2 and 3, a substrate 4 is disposed on the lower case 3, a disk-shaped garnet ferrite element 5 and center conductors 6A, 6B, and 6C, which are electrically connected to the lower side of the garnet ferrite element 5 via a common electrode, are disposed on the substrate 4, and a magnet 7 is disposed on the garnet ferrite element 5 and the center conductors 6A, 6B, and 6C.

The upper case 2 and the lower case 3 are substantially U-shaped magnetic cases. By combining the upper and lower cases 2 and 3, a boxed case is formed. The upper and lower cases 2 and 3, together, function as a yoke. The substrate 4 includes a resin base 4A having a circular through hole 4a. Patterned electrodes (matching capacitors) 4b are disposed on the regions in the three corners on one of the sides of the base 4, and an earth electrode 4c is disposed on the regions in the remaining corner. The substrate 4 also includes a resistive element 4d electrically connected to one of the patterned electrodes 4b and the earth electrode 4c.

The garnet ferrite element (garnet ferrite for a non-reciprocal circuit element) 5 is a disk composed of the after-mentioned garnet ferrite. On the periphery of the garnet ferrite element 5, the center conductors 6A, 6B, and 6C composed of metal strips are wrapped around the garnet ferrite element 5 so that the metal strips intersect at the center of the disk at a 60° angle. The garnet ferrite element 5 is disposed inside the through hole 4a of the substrate 4 and the ends of the center conductors 6A, 6B, and 6C are electrically connected to the patterned electrodes 4b. The other ends of the center conductors 6A, 6B, and 6C are integrated to a common electrode not depicted in the drawing. On the center conductors 6A, 6B, and 6C, the disk-shaped magnet 7, which applies a bias magnetic field in the vertical direction of the garnet ferrite element 5, is disposed. The substrate 4 including the garnet ferrite element 5, the center conductors 6A, 6B, and 6C, and the magnet 7, as described above, are interposed between the upper and lower cases 2 and 3 to make up the isolator 1.

The garnet ferrite element 5 is composed of a garnet ferrite that can be expressed by the following formula (1):
Y₃₋ₓGdₓFe_{t-2y-z}Co_{y}Si_{y}Al_{z}O₁₂ (1)
(where x, y, z, and t indicate the composition ratio within the formula, wherein 0.2≦x≦1.5, 0.005≦y≦0.015, 0≦z≦1.5, and 4.75≦t≦5).

Preferably, x, y, z, and t are within the range of 0.2≦x≦1.25, 0.005≦y≦0.01, 0≦z≦1.5, and 4.75≦t≦4.9.

When the garnet ferrite element 5 is composed of the garnet ferrite expressed by the formula (1), the sum of the composition ratios of yttrium and gadolinium is 3, wherein the composition ratio of yttrium is in the range of 1.5 or more to 2.8 or less.

By setting the gadolinium ratio in the range of 0.2 or more to 1.5 or less, the absolute temperature coefficient a of 4πMs can be reduced. Moreover, since the temperature coefficient of the surface flux of the magnet 7 used for the isolator 1 is a negative value, by setting the gadolinium ratio in the range of 0.2 or more to 1.5 or less, the temperature coefficient for room temperature becomes zero or approximately zero. Furthermore, it is preferable to set the gadolinium ratio to 1.25 or less because the ferromagnetic resonance half-width ΔH will be reduced to 6,000 A·m⁻¹ or less.

It is preferable to set the gadolinium ratio to 1.0 or less because the temperature coefficient α of the garnet ferrite element 5 will be a negative value over the entire temperature range. In this way, the slopes of the temperature coefficient α of the garnet ferrite element 5 will match the slopes of the temperature coefficient of the surface flux of the magnet 7. As a result, the stability of the isolator 1 is increased.

If the gadolinium ratio is less than 0.2, the advantage gained by the reduction of the ferromagnetic resonance half-width ΔH by adding Co—Si will be lost.

Setting the copper ratio and the silicon ratio in the range of 0.005 or more to 0.015 or less reduces the ferromagnetic resonance half-width ΔH. It is preferable to set the copper ratio and the silicon ratio in the range of 0.005 or more to 0.01 or less since the ferromagnetic resonance half-width ΔH will be effectively reduced. When the copper ratio and the silicon ratio exceed 0.015, the ferromagnetic resonance half-width ΔH is increased. When the copper ratio and the silicon ratio are less than 0.005, the advantage gained by the reduction of the ferromagnetic resonance half-width ΔH will be lost.

By setting the aluminum ratio in the range of 0 or more to 1.5 or less, the 4πMs value can be adjusted. When the aluminum ratio exceeds 1.5, the 4πMs is reduced to zero. Thus, it is preferable to set the upper limit of the aluminum ratio as 1.5 so that a 4πMs value having a practical magnitude will be obtained.

The sum of the composition ratios of iron, copper, silicon, and aluminum equals t.

By setting the composition ratio of t in the range of 4.75 or more to 5 or less, the garnet in the garnet ferrite element 5 forms a single-phase garnet not including any precipitation of a hetero-phase. Consequently, the ferromagnetic resonance half-width ΔH is reduced. When the composition ratio of t is less than 4.75, the garnet in the garnet ferrite element 5 does not form a single-phase, and a hetero-phase precipitates. As a result, the ferromagnetic resonance half-width ΔH increases suddenly. The ferromagnetic resonance half-width ΔH also increases suddenly when the composition ratio of t exceeds 5. It is preferable to set the composition ratio of t in the range of 4.75 or more to 4.9 or less, so that the ferromagnetic resonance half-width ΔH is effectively reduced.

The sum of the ratios of iron, copper, silicon, and aluminum is in the range of 4.75 or more to 5 or less, and, preferably, it is in the range of 4.75 or more to 4.9 or less. When the iron ratio is set to 5 or less, the ferromagnetic resonance half-width ΔH decrease, but, when the iron ration is set below 4.75 or less, an insufficient value for the ferromagnetic resonance half-width ΔH is obtained.

The garnet ferrite element 5 may also be composed of a garnet ferrite that can be expressed by the following formula (2):
Y₃₋ₓ₋ᵤGdₓCaᵤFe_{t-2y-u-z}Co_{y}Si_{y}DᵤAl_{z}O₁₂ (2)
(where D represents at least one of zirconium, hafnium, and tin, and x, y, z, t, and u indicate the composition ratio within the formula, wherein 0.2≦x≦1.5, 0.005≦y≦0.015, 0≦z≦1.5, 4.75≦t≦5, 0≦u≦0.3).

Preferably, x, y, z, t, and u are in the ranges of 0.2≦x≦1.25, 0.005≦y≦0.01, 0≦z≦1.5, 4.75≦t≦4.9, 0.04≦t≦0.2.

When the garnet ferrite element 5 is composed of the garnet ferrite expressed by the formula (2), the sum of the composition ratios of yttrium, gadolinium, and calcium is 3, wherein the yttrium ratio is in the range of 1.2 or more to 2.76 or less.

It is preferable to set the composition ratios of both calcium and D in the range of 0 or more to 0.3 or less since the ferromagnetic resonance half-width ΔH will be effectively reduced. When the composition ratios of both calcium and D exceed 0.3, the ferromagnetic resonance half-width ΔH will not be reduced any further and the absolute temperature coefficient α will be increased. It is preferable to set the composition ratios of both calcium and D in the range of 0.04 or more to 0.2 or less to balance the temperature coefficient α and the ferromagnetic resonance half-width ΔH. Moreover, when the composition ratios of both calcium and D are in the range of 0.1 or more to 0.16 or less, the absolute temperature coefficient α and the ferromagnetic resonance half-width ΔH will both be reduced.

The sum of the composition ratios of iron, copper, silicon, aluminum, and D equals t. By setting the composition ratio t in the range of 4.75 or more to 5 or less, the garnet in the garnet ferrite element 5 forms a single-phase without precipitation of a hetero-phase and ΔH is reduced.

The sum of the composition ratios of iron, copper, silicon, aluminum, and D is in the range of 4.75 or more to 5 or less, and, preferably, it is in the range of 4.75 or more to 4.9 or less.

The garnet ferrite element 5 is composed of a garnet ferrite that can be expressed by the following formula (3):
Y₃₋ₓGdₓFe_{t-2y-v-z}Co_{y}Si_{y}InᵥAl_{z}O₁₂ (3)
(where x, y, z, t, and v indicate the composition ratio within the formula, wherein 0.2≦x≦1.5, 0.005≦y≦0.015, 0≦z≦1.5, 4.75≦t≦5, 0≦v≦0.2).

Preferably, x, y, z, t, and v are 0.2≦x≦1.25, 0.005≦y≦0.01, 0≦z≦1.5, 4.75≦t≦4.9, 0.04≦v≦0.2, respectively.

By setting the indium ratio in the range of 0 or more to 0.2 or less, the ferromagnetic resonance half-width ΔH of 4πMs can be reduced. It is preferable to set the indium ratio in the range of 0.04 or more to 0.2 or less since the ferromagnetic resonance half-width ΔH will be effectively reduced. Even if indium is added so that the indium ratio of exceeds 0.2, the ferromagnetic resonance half-width ΔH will not be reduced any further and the absolute temperature coefficient α will be increased. It is preferable to set the indium ratio in the range of 0.04 or more to 0.2 or less and to add the indium compositely with the gadolinium to maintain a balance between the temperature coefficient α and the ferromagnetic resonance half-width ΔH. Moreover, it is preferable to set the indium ratio in the range of 0.1 or more to 0.16 or less, so that the absolute temperature coefficient α and the ferromagnetic resonance half-width ΔH will both be reduced.

The sum of the composition ratios of iron, copper, silicon, indium, and aluminum equals t. By setting the composition ratio t in the range of 4.75 or more to 5 or less, the garnet in the garnet ferrite element 5 forms a single-phase a single-phase of garnet not including any precipitation of a hetero-phase and the ferromagnetic resonance half-width ΔH is reduced.

The sum of the composition ratios of iron, copper, silicon, indium, and aluminum is in the range of 4.75 or more to 5 or less, and, preferably, it is in the range of 4.75 or more to 4.9 or less.

According to one of the examples of garnet ferrite element 5 expressed by the formulas (1) to (3), the absolute temperature coefficient α is reduced and the ferromagnetic resonance half-width ΔH can be reduced to 6,000 A·m⁻¹ or less. Even if the garnet ferrite element 5 has the same temperature coefficient α as a known garnet ferrite, the ferromagnetic resonance half-width ΔH is lower than the known garnet ferrite. By adjusting the amount of aluminum, the 4πMs value can be adjusted to a value preferable for a high-frequency band. By adjusting the amount of gadolinium when the garnet ferrite element 5 is used in combination with the magnet 7 in the isolator 1, the temperature coefficient of the magnet 7 can be compensated for.

A method for preparing the garnet ferrite element 5 will now be described below.

To prepare the garnet ferrite element 5, first, calcined powder composing the garnet ferrite to be prepared is obtained as raw materials. Then, the oxides are mixed to obtain the composition ratio of the desired garnet ferrite.

For example, to prepare a Y—Gd—Fe—Co—Si—Al—O type garnet ferrite, powders of Y₂O₃, Gd₂O₃, Fe₂O₃, Co₃O₄, SiO₂, and Al₂O₃ are prepared. Similarly, to prepare a Y—Ca—Fe—Co—Si-D-Al—O (where D is tin, zirconium, or hafnium) type garnet ferrite, powders of Y₂O₃, CaCO₃, Fe₂O₃, Co₃O₄, SiO₂, and Al₂O₃, and a powder of SnO₂, ZrO₂l or HfO₂ are prepared. Similarly, to prepare a Y—Gd—Fe—Co—Si—In—Al—O type garnet ferrite, powders of Y₂O₃, Gd₂O₃, Fe₂O₃, Co₃O₄, SiO₂, In₂O₃, and Al₂O₃ are prepared. Here, the desired garnet ferrite is expressed by one of the formulas (1) to (3).

The raw materials of the garnet ferrite are preferably in powder form. Then, the powders are weighed to obtain the predetermined composition ratio. When granular or solid raw materials are used, the raw materials must be mixed and, then, pulverized in a pulverizer, such as a ball mill or an attritor, for a sufficient amount of time (several minutes to several hours). If the pulverizing blade, ball, or inner wall of the ball mill or a planetary mill contains iron or if the ball or inner wall of the pulverizing ball of the attritor contains iron, the iron might contaminate the powder. Thus, it is preferable to use a mill or attritor that does not contain iron in parts that come into contact with the pulverized powder.

In other words, the blade edge and the part of the ball mill that contains the powder may be composed of a material other than iron, whereas the pulverizing ball of the attritor may be composed of alumina, zirconia, or a metal coated with calcium titanate. In this way, iron is not transferred to the powder. Moreover, the inner walls of the mill and attritor may be composed of a resin such as nylon.

More specifically, when using a pulverizing apparatus such as a ball mill, zirconia balls and calcined powder is disposed in a nylon resin cylindrical container having an outer diameter of 180 mm (and an inner diameter of 135 mm), and a nylon resin cover is disposed over the opening of the container. The covered container is disposed on two horizontal rotary shafts (wherein the rotary shafts are positioned substantially in parallel so that the distance between the shafts is slightly smaller than the diameter of the container). Then, the rotary shafts are rotated to drive the container to rotate along its circumference at 80 to 100 rpm for 16 to 20 hours. By agitating the zirconia ball together with the calcined powder causes the calcined powder to pulverize.

When pulverized raw materials are used, this process of pulverizing the raw materials may be omitted.

After drying the mixed calcined powder, they are calcined in an air or oxygen environment at 1,000° C. to 1,200° C. for a predetermined amount of time, such as several hours, to obtain a calcined powder.

Then, the calcined powder is pulverized in the ball mill or attritor again. At this time, also, it is preferable to use a ball mill or an attritor that satisfies the above-mentioned conditions for preventing iron contamination.

After the particle size of the calcined powder is uniformized, the calcined powder is molded together with a binder to obtain a predetermined shape. Then, a pressure of about 1 t/cm² is applied to form the predetermined shape, such as a disk, plate, or rectangular column. Subsequently, the molded calcined powder is sintered at a temperature of about 1,350° C. to 1,500° C. In this way, the disk-shaped garnet ferrite element 5 is prepared.

It is also possible to mold the calcined powdered into a shape similar to the shape of the final product, and, then, cut out the molded calcined powder into the shape of the final product.

As illustrated in FIG. 1, the isolator 1 is formed by the steps of: disposing the center conductors 6A, 6B, and 6C onto the disk-shaped garnet ferrite element 5, prepared as described above; disposing the garnet ferrite element 5 into the through hole 4a on the substrate 4; and, finally, positioning the garnet ferrite element 5 inside the upper and lower cases 2 and 3 along with the magnet 7.

When the garnet ferrite element 5, prepared as described above, is used for the isolator 1, the garnet ferrite element 5 has a low insertion loss and a low ferromagnetic resonance half-width ΔH in a high-frequency band higher than 500 MHz (or, for example, in a 10 GHz bandwidth).

The ferromagnetic resonance half-width ΔH of the garnet ferrite element 5 used for the isolator 1 refers to the half-width of the peak value of the imaginary part R of the magnetic permeability. Usually, the magnetic permeability of a magnetic body is measured in the direction the magnetic field is applied. In this case, however, the ferromagnetic resonance half-width ΔH is obtained from the imaginary part of the magnetic permeability measured when a high-frequency magnetic field is applied in a direction orthogonal to the direction of a static magnetic field in saturation. The lower the ferromagnetic resonance half-width ΔH, the lower the loss.

The magnetic temperature coefficients α(−35) and α(85) are calculated as follows:
α(−35)=[{4πMs(25° C.)−4πMs(−35° C.)}/4πMs(25° C.)]×(100/60) [%° C.⁻¹]
α(85)=[{4πMs(85° C.)−4πMs(25° C.))/4πMs(25° C.)]×(100/60) [%° C.⁻¹]

In the formulas above, 4πMs(−35° C.), 4πMs(25° C.), and 4πMs(85° C.) are the 4πMs (saturation magnetization) values for the garnet ferrite at −35° C., 25° C., and 85° C., respectively.

The isolator 1 according to this embodiment includes a magnetic assembly, the magnet 7 for applying a direct current magnetic field to the magnetic assembly, the matching capacitors 4b, and a yoke (upper and lower cases 2 and 3) for holding all the components. The magnetic assembly is made up of a main body (garnet ferrite element 5) and the center conductors 6A, 6B, and 6C are disposed on the upper surface of the main body so that each of the center conductors 6A, 6B, and 6C intersect at a predetermined angle while being electrically insulated from each other. This structure of the isolator 1 suppresses the loss in a high-frequency band such as the microwave band and stabilizes the isolation characteristic even when the environmental temperature changes.

Thus, the isolator 1 including the garnet ferrite element 5 is preferably used for a transmitter by interposing the isolator 1 between an amplifier and an antenna. In this way, the isolator 1 functions as an excellent two-terminal element for suppressing noise from the antenna from returning to the amplifier.

### EXAMPLES 1-1 TO 1-24

Y₂O₃, Gd₂O₃, Fe₂O₃, Co₃O₄, SiO₂, and Al₂O₃ powders were mixed to obtain the composition ratio shows in Tables 1 and 2 in a ball mill (using steel balls coated with a ceramic). The mixture was dried, and, then, fired for four hours at 1,200° C. to prepare a calcined powder. The calcined powder was returned to the ball mill (or the equivalent) together with an organic binder and was wet milled for 20 hours. The wet-milled product was sintered in an air or oxygen environment at 1,350° C. to 1,500° C. In this way, a garnet ferrite sample having a composition of Y₃₋ₓGdₓFe_{t-2y-z}Co_{y}Si_{y}Al_{z}O₁₂ (according to Examples 1-1 to 1-24) was obtained.

The measured results of the garnet ferrite sample, the 4πMs, the magnetic temperature coefficient α (−35) at −35° C. to +25° C., the magnetic temperature coefficient α (85) for +25° C. to +85° C., and the ferromagnetic resonance half-width ΔH (the half-width of the peak value of the imaginary part μ of the magnetic permeability of each sample) at an operational frequency of 10 GHz of the garnet ferrite sample according to Examples 1-1 to 1-24 are shown in Tables 1 and 2. The magnetic permeability of the garnet ferrite sample was determined by measuring the magnetic permeability in the orthogonal direction of a static magnetic field, wherein a high-frequency magnetic field for measurement was applied in a direction orthogonal to the static magnetic field while the static magnetic field was electrically saturated by applying a bias. The half-width of the peak value of the imaginary part μ of the magnetic permeability measured in this way is the ferromagnetic resonance half-width ΔH.

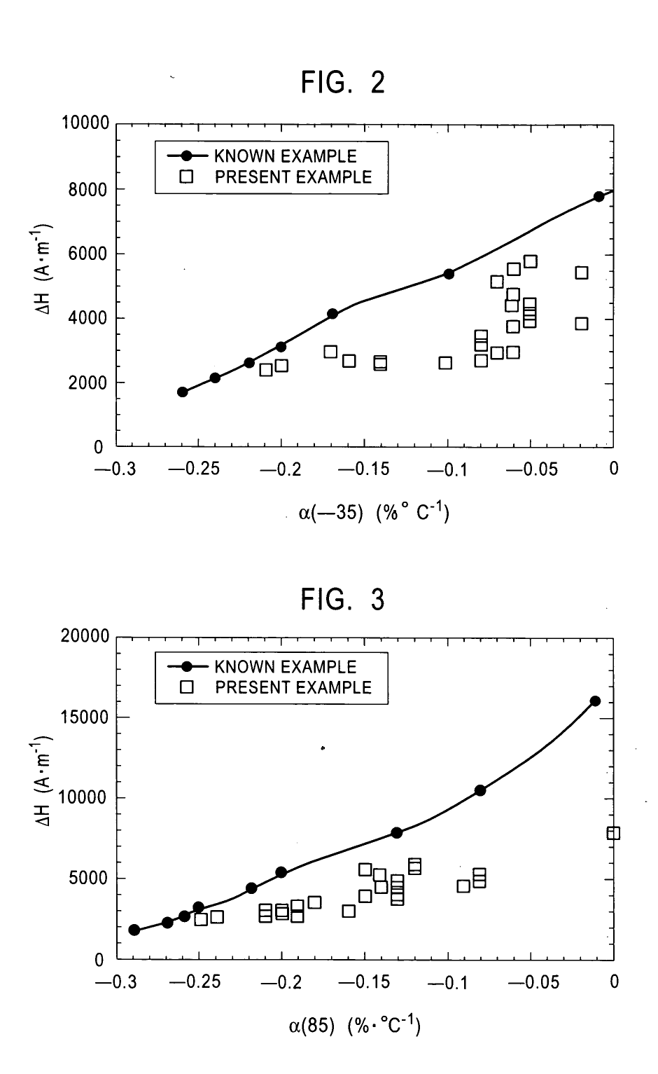

The relationship between the magnetic temperature coefficient α(−35) and the ferromagnetic resonance half-width ΔH of the garnet ferrite samples according to Examples 1-1 to 1-24 is shown in FIG. 2, and the relationship between temperature coefficient α(85) and the ferromagnetic resonance half-width ΔH of the garnet ferrite samples according to Examples 1-1 to 1-24 is shown in FIG. 3.

TABLE 1
Y₃₋ₓGdₓFe_{t-2y-z}Co_{y}Si_{y}Al_{z}O₁₂

| EXAMPLE No. | x | y | z | t | 4π Ms(T) | α(−35)(% · ° C.⁻¹) | α(85)(% · ° C.⁻¹) | ΔH(A · m⁻¹) |
|---|---|---|---|---|---|---|---|---|
| 1-1 | 0.2 | 0.01 | 0.33 | 4.883 | 0.125 | −0.21 | −0.25 | 2460 |
| 1-2 | 0.3 | 0.01 | 0.33 | 4.883 | 0.121 | −0.20 | −0.24 | 2600 |
| 1-3 | 0.5 | 0.01 | 0.33 | 4.883 | 0.110 | −0.16 | −0.21 | 2780 |
| 1-4 | 0.55 | 0.01 | 0.32 | 4.883 | 0.109 | −0.17 | −0.21 | 3020 |
| 1-5 | 0.6 | 0.01 | 0.25 | 4.883 | 0.115 | −0.14 | −0.19 | 2630 |
| 1-6 | 0.6 | 0.01 | 0.28 | 4.883 | 0.112 | −0.14 | −0.19 | 2710 |
| 1-7 | 0.7 | 0.01 | 0.25 | 4.883 | 0.109 | −0.10 | −0.19 | 2710 |
| 1-8 | 0.8 | 0.01 | 0.25 | 4.883 | 0.104 | −0.06 | −0.16 | 3020 |
| 1-9 | 1.0 | 0.005 | 0.20 | 4.883 | 0.099 | −0.02 | −0.15 | 3900 |
| 1-10 | 1.0 | 0.01 | 0.20 | 4.883 | 0.100 | −0.05 | −0.13 | 4220 |
| 1-11 | 1.0 | 0.015 | 0.20 | 4.883 | 0.097 | −0.02 | −0.15 | 5490 |
| 1-12 | 1.25 | 0.01 | 0.00 | 4.883 | 0.114 | 0.03 | −0.08 | 5250 |
| 1-13 | 1.25 | 0.01 | 0.01 | 4.883 | 0.111 | 0.03 | −0.09 | 4620 |
| 1-14 | 1.25 | 0.01 | 0.33 | 4.883 | 0.071 | 0.11 | −0.08 | 4780 |
| 1-15 | 1.5 | 0.01 | 0.33 | 4.883 | 0.056 | 0.29 | 0 | 7800 |

α(−35): Magnetization Temperature Coefficient at −35° C. to 25° C.
α(85): Magnetization Temperature Coefficient at 25° C. to 85° C.

TABLE 2
Y₃₋ₓGdₓFe_{t-2y-z}Co_{y}Si_{y}Al_{z}O₁₂

| EXAMPLE No. | x | y | z | t | 4π Ms(T) | α(−35)(% · ° C.⁻¹) | α(85)(% · ° C.⁻¹) | ΔH(A · m⁻¹) |
|---|---|---|---|---|---|---|---|---|
| 1-16 | 1.0 | 0.01 | 0.20 | 5.000 | 0.100 | −0.05 | −0.12 | 5830 |
| 1-17 | 1.0 | 0.01 | 0.20 | 4.985 | 0.100 | −0.06 | −0.12 | 5610 |
| 1-18 | 1.0 | 0.01 | 0.20 | 4.955 | 0.101 | −0.06 | −0.13 | 4800 |
| 1-19 | 1.0 | 0.01 | 0.20 | 4.925 | 0.101 | −0.05 | −0.13 | 4500 |
| 1-20 | 1.0 | 0.01 | 0.20 | 4.895 | 0.101 | −0.05 | −0.13 | 4020 |
| 1-21 | 1.0 | 0.01 | 0.20 | 4.835 | 0.101 | −0.06 | −0.13 | 3820 |
| 1-22 | 1.0 | 0.01 | 0.20 | 4.801 | 0.102 | −0.06 | −0.13 | 3830 |
| 1-23 | 1.0 | 0.01 | 0.20 | 4.770 | 0.102 | −0.06 | −0.14 | 4500 |
| 1-24 | 1.0 | 0.01 | 0.20 | 4.750 | 0.102 | −0.07 | −0.14 | 5200 |

α(−35): Magnetization Temperature Coefficient at −35° C. to 25° C.
α(85): Magnetization Temperature Coefficient at 25° C. to 85° C.

In Tables 1 and 2, x, y, z, and t represent the composition ratios of the elements composing the garnet ferrite expressed by the formula:
Y₃₋ₓGdₓFe_{t-2y-z}Co_{y}Si_{y}Al_{z}O₁₂

### Comparative Examples

A garnet ferrite sample having a composition expressed by the formula Y₃₋ₓGdₓFe_{t-2y-z}Co_{y}Si_{y}Al_{z}O₁₂ (according to Comparative Examples 1-1 to 1-9) was obtained in the same manner as in the above-mentioned examples, except that Y₂O₃, Fe₂O₃, Co₃O₄, SiO₂, and Al₂O₃ powders, and, if necessary, a Gd₂O₃ powder were used to obtain the composition ratio shown in Table 3. The measured results of the 4πMs value, the temperature coefficients α(−35) and α(85), and the ferromagnetic resonance half-width ΔH of a garnet ferrite sample according to the Comparative Examples 1-1 to 1-9 are shown in Table 3.

TABLE 3
Y₃₋ₓGdₓFe_{t-2y-z}Co_{y}Si_{y}Al_{z}O₁₂

| COMPARATIVE | | | | | | | | |
|---|---|---|---|---|---|---|---|---|
| EXAMPLE | x | y | z | t | 4π Ms(T) | α(−35)(% · ° C.⁻¹) | α(85)(% · ° C.⁻¹) | ΔH(A · m⁻¹) |
| 1-1 | 0 | 0.01 | 0.33 | 4.883 | 0.137 | −0.26 | −0.29 | 1890 |
| 1-2 | 0.1 | 0.01 | 0.33 | 4.883 | 0.132 | −0.23 | −0.27 | 2350 |
| 1-3 | 1.55 | 0.01 | 0.33 | 4.883 | 0.054 | 0.33 | 0.01 | 9000 |
| 1-4 | 1.0 | 0 | 0.20 | 4.883 | 0.100 | −0.05 | −0.14 | 6210 |
| 1-5 | 1.0 | 0.02 | 0.20 | 4.883 | 0.096 | −0.02 | −0.14 | 7640 |
| 1-6 | 0.2 | 0.01 | 1.55 | 4.883 | ≦0.005 | — | — | — |
| 1-7 | 1.25 | 0.01 | 1.05 | 4.883 | ≦0.005 | — | — | — |
| 1-8 | 1.0 | 0.01 | 0.20 | 5.035 | 0.100 | −0.05 | −0.13 | 6800 |
| 1-9 | 1.0 | 0.01 | 0.20 | 4.740 | 0.102 | −0.07 | −0.14 | 7800 |

α(−35): Magnetization Temperature Coefficient at −35° C. to 25° C.
α(85): Magnetization Temperature Coefficient at 25° C. to 85° C.

In Table 3, x, y, z, and t represent the composition ratios of the elements composing the garnet ferrite expressed by the formula:
Y₃₋ₓGdₓFe_{t-2y-z}Co_{y}Si_{y}Al_{z}O₁₂

### Known Examples

A garnet ferrite sample having a composition expressed by the formula Y₃₋ₓGdₓFe_{4.883-z}Al_{z}O₁₂ (according to Known Examples 1 to 9) was obtained in the same manner as in the above-mentioned examples, except that Y₂O₃, Fe₂O₃, and Al₂O₃ powders, and, if necessary, a Gd₂O₃ powder were used to obtain the composition ratio shown in Table 4. The measured results of the 4πMs value, the temperature coefficients α(−35) and α(85), and the ferromagnetic resonance half-width ΔH of a garnet ferrite sample according to Known Examples 1 to 9 are shown in Table 3. Furthermore, the relationship between the temperature coefficient α(−35) and the ferromagnetic resonance half-width ΔH and the temperature coefficient α(85) and the ferromagnetic resonance half-width ΔH of a garnet ferrite sample according to Known Examples 1 to 9 are shown in Tables 2 and 3, respectively.

TABLE 4
Y₃₋ₓGdₓFe_{4.883-z}Al_{z}O₁₂

| KNOWN | | | | | | |
|---|---|---|---|---|---|---|
| EXAMPLE No. | x | z | 4π Ms(T) | α(−35)(% · ° C.⁻¹) | α(85)(% · ° C.⁻¹) | ΔH(A · m⁻¹) |
| 1 | 0.0 | 0.33 | 0.138 | −0.26 | −0.29 | 1750 |
| 2 | 0.1 | 0.33 | 0.133 | −0.24 | −0.27 | 2200 |
| 3 | 0.2 | 0.33 | 0.127 | −0.22 | −0.26 | 2610 |
| 4 | 0.3 | 0.33 | 0.122 | −0.20 | −0.25 | 3160 |
| 5 | 0.5 | 0.33 | 0.112 | −0.17 | −0.22 | 4300 |
| 6 | 0.7 | 0.33 | 0.101 | −0.10 | −0.20 | 5400 |
| 7 | 1.0 | 0.33 | 0.085 | −0.01 | −0.13 | 7800 |
| 8 | 1.25 | 0.33 | 0.073 | 0.11 | −0.08 | 10350 |
| 9 | 1.5 | 0.33 | 0.059 | 0.28 | −0.01 | 16200 |

α(−35): Magnetization Temperature Coefficient at −35° C. to 25° C.
α(85): Magnetization Temperature Coefficient at 25° C. to 85° C.

In Table 4, x and z represent the composition ratios of the elements composing the garnet ferrite expressed by the formula:
Y₃₋ₓGdₓFe_{4.883-z}Co_{y}Si_{y}Al_{z}O₁₂

According to the results shown in Tables 1 to 4 and FIGS. 2 and 3, even when the temperature coefficient α of the sample according to an example of the present invention was the same as the temperature coefficient α of a known example, the ferromagnetic resonance half-width ΔH was low.

When the gadolinium ratio was the same for the sample according to an example of the present invention and a known example, the ferromagnetic resonance half-width ΔH was lower for the example according to the present invention because copper and silicon were also added. More specifically, the ferromagnetic resonance half-width ΔH was 2,610 A·m⁻¹ for the sample according to Known Example 3 having a gadolinium (x) ratio of 0.2. The ferromagnetic resonance half-width ΔH was 2,460 A·m⁻¹ for the sample according to Example 1-1 having a gadolinium (x) ratio of 0.2 and a copper (y) ratio and a silicon ratio (y) of 0.01. In other words, the ferromagnetic resonance half-width ΔH was lower for Example 1-1 compared to Known Example 3.

The temperature coefficient α of a sample according to Comparative Example 1-3 having a gadolinium (x) ratio of 1.55 was a positive value for all temperature ranges. In comparison, the temperature coefficient α of a sample according to Comparative Example 1-15 having a gadolinium (x) ratio of 1.50 was positive for the temperature coefficient α(−35) but was zero for temperature coefficient α(85). In other words, if the c gadolinium ratio is 1.5 or less, the temperature coefficient α can be matched with the temperature coefficient of the surface flux of the magnet at at least room temperature. For the examples having a gadolinium ratio of 1.25 or less, the ferromagnetic resonance half-width ΔH was 5,830 A·m⁻¹ or less. For the examples having a gadolinium ratio of 1.0 or less, the temperature coefficient α was a negative value over the temperature range, which is the same (negative value) as the surface flux of the magnet.

Consequently, the upper limit of the composition ratio for gadolinium was set to 1.5, preferably set to 1.25 or less, and more preferably set to 1.0 or less.

The temperature coefficients α(−35) and α(85) of a sample according to Comparative Example 1-5 having a copper ratio and a silicon ratio of 0.02, were −0.02%·° C.⁻¹ and −0.14%·° C.⁻¹, respectively, but the ferromagnetic resonance half-width ΔH was 7,640 A·m⁻¹, which is significantly high. In comparison, the temperature coefficients α(−35) and α(85) of a sample according to Example 1-11 having a copper ratio and a silicon ratio of 0.015, were −0.02%·° C.⁻¹ and −0.15%·° C.⁻¹, respectively, but the ferromagnetic resonance half-width ΔH was 5,490 A·m⁻¹, which was low in comparison with Comparative Example 1-5. Furthermore, the ferromagnetic resonance half-width ΔH of Example 1-11 was lower than 6,210 A·m⁻¹, which was the ferromagnetic resonance half-width ΔH for Comparative Example 1-4 having no copper or silicon added. By taking all of these facts into consideration, the upper limits for the composition ratios of copper and silicon were both set to 0.015.

The ferromagnetic resonance half-width ΔH for Comparative Example 1-4 having no copper and silicon added was 6,210 A·m⁻¹, which is relatively large. On the other hand, the ferromagnetic resonance half-width ΔH for the sample according to Example 1-9 having a copper ratio and a silicon ratio of 0.005, was 3,900 A·m⁻¹, which was lower than the ferromagnetic resonance half-width ΔH for Comparative Example 1-4. Accordingly, the lower limits for the composition ratio of copper and silicon were both set to 0.005.

The 4πMs value for Comparative Example 1-6 having an aluminum ratio of 1.55 was almost zero.

The temperature coefficients α(−35) and α(85) of Comparative Examples 1-8 and 1-9 having a t ratio of 5.035 and 4.740, respectively, were low but the ferromagnetic resonance half-width values ΔH for Comparative Examples 1-8 and 1-9 were 6,800 A·m⁻¹ or more, which were significantly high. Accordingly, the range of the composition ratio for t was set to 4.75 to 5.

### EXAMPLES 2-1 TO 2-3

A garnet ferrite sample having a composition expressed by the formula Y_{1.9}Gd₁Ca_{0.1}Fe_{4.563}Co_{0.01}Si_{0.01}D_{0.1}Al_{0.2}O₁₂ (where D represents zirconium, hafnium, or tin) (according to Examples 2-1 to 2-3) was obtained in the same manner as in the above-mentioned examples, except that Y₂O₃, Gd₂O₃, Fe₂O₃, Co₃O₄, SiO₂, and Al₂O₃ powders, and, a SnO₂, ZrO₂, or HfO₂ powder were used to obtain the composition ratio shown in Table 5. The measured results of the 4πMs values, the temperature coefficient α(−35) and α(85), and the ferromagnetic resonance half-width ΔH of a garnet ferrite sample according to Examples 2-1 to 2-3 are shown in Table 5.

### Comparative Examples 2-1 to 2-3

A garnet ferrite sample having a composition expressed by the formula Y_{1.9}Gd₁Ca_{0.1}Fe_{4.583}D_{0.1}Al_{0.2}O₁₂ (where D represents zirconium, hafnium, or tin) (according to Comparative Examples 2-1 to 2-3) was obtained in the same manner as in the above-mentioned examples, except that Y₂O₃, Gd₂O₃, Fe₂O₃, and Al₂O₃ powders, and, a SnO₂, ZrO₂, or HfO₂ powder were used to obtain the composition ratio shown in Table 6. The measured results of the 4πMs values, the temperature coefficient α(−35) and α(85), and the ferromagnetic resonance half-width ΔH of a garnet ferrite sample according to the Comparative Examples 2-1 to 2-3 are shown in Table 6.

TABLE 5
Y_{1.9}Gd₁Ca_{0.1}Fe_{4.563}Co_{0.01}Si_{0.01}D_{0.1}Al_{0.2}O₁₂

| EXAMPLE No. | D | 4π Ms(T) | α(−35)(% · ° C.⁻¹) | α(85)(% · ° C.⁻¹) | ΔH(A · m⁻¹) |
|---|---|---|---|---|---|
| 2-1 | Zr | 0.112 | −0.07 | −0.20 | 3050 |
| 2-2 | Hf | 0.109 | −0.08 | −0.18 | 3510 |
| 2-3 | Sn | 0.112 | −0.08 | −0.20 | 2790 |

α(−35): Magnetization Temperature Coefficient at −35° C. to 25° C.
α(85): Magnetization Temperature Coefficient at 25° C. to 85° C.

TABLE 6
Y_{1.9}Gd₁Ca_{0.1}Fe_{4.583}D_{0.1}Al_{0.2}O₁₂

| COMPARATIVE | | | | | |
|---|---|---|---|---|---|
| EXAMPLE No. | D | 4π Ms(T) | α(−35)(% · ° C.⁻¹) | α(85)(% · ° C.⁻¹) | ΔH(A · m⁻¹) |
| 2-1 | ZR | 0.113 | −0.08 | −0.20 | 3740 |
| 2-2 | Hf | 0.110 | −0.09 | −0.18 | 4300 |
| 2-3 | Sn | 0.115 | −0.09 | −0.19 | 3420 |

α(−35): Magnetization Temperature Coefficient at −35° C. to 25° C.
α(85): Magnetization Temperature Coefficient at 25° C. to 85° C.

From the results shown in Tables 5 and 6, the ferromagnetic resonance half-width ΔH of the sample according to Comparative Example 2-1 having zirconium and calcium added was 3,740 A·m⁻¹. On the other hand, the ferromagnetic resonance half-width ΔH of the sample according to Example 2-1 having zirconium, calcium, copper, and silicon added was 3,050 A·m⁻¹. In other words, the ferromagnetic resonance half-width ΔH was reduced in comparison with the ferromagnetic resonance half-width ΔH of the Comparative Example when the temperature coefficient α was negative over the temperature range.

The ferromagnetic resonance half-width ΔH of the sample according to Comparative Example 2-2 having hafnium and calcium added was 4,300 A·m⁻¹. On the other hand, the ferromagnetic resonance half-width ΔH of the sample according to Example 2-2 having hafnium, calcium, copper, and silicon added was 3,510 A·m⁻¹. In other words, the ferromagnetic resonance half-width ΔH was reduced in comparison with the ferromagnetic resonance half-width ΔH of the Comparative Example when the temperature coefficient α was negative over the temperature range.

The ferromagnetic resonance half-width ΔH of the sample according to Comparative Example 2-3 having tin and calcium added was 3,420 A·m⁻¹. On the other hand, the ferromagnetic resonance half-width ΔH of the sample according to Example 2-3 having tin, calcium, copper, and silicon added was 2,790 A·m⁻¹. In other words, the ferromagnetic resonance half-width AH was reduced in comparison with the ferromagnetic resonance half-width ΔH of the Comparative Example when the temperature coefficient α was negative over the temperature range.

A garnet ferrite sample having a composition expressed by the formula Y₂Gd₁Fe_{4.563}Co_{0.01}Si_{0.01}In_{0.1}Al_{0.2}O₁₂ (according to Example 3-1) was obtained in the same manner as in the above-mentioned examples, except that Y₂O₃, Gd₂O₃, Fe₂O₃, Co₃O₄₁ SiO₂, In₂O₃ and Al₂O₃ powders were used to obtain the composition ratio shown in Table 7. The measured results of the 4πMs values, the temperature coefficient α(−35) and α(85), and the ferromagnetic resonance half-width ΔH of a garnet ferrite sample according to Example 3-1 are shown in Table 7.

### Comparative Example 3-1

A garnet ferrite sample having a composition expressed by the formula Y₂Gd₁Fe_{4.583}In_{0.1}Al_{0.2}O₁₂ (according to Comparative Example 3-1) was obtained in the same manner as in the above-mentioned examples, except that Y₂O₃, Gd₂O₃, Fe₂O₃, In₂O₃, and Al₂O₃ powders were used to obtain the composition ratio shown in Table 8. The measured results of the 4πMs values, the temperature coefficients α(−35) and α(85), and the ferromagnetic resonance half-width ΔH of a garnet ferrite sample according to Comparative Example 3-1 are shown in Table 8.

TABLE 7
Y₂Gd₁F_{4.563}Co_{0.01}Si_{0.01}In_{0.1}Al_{0.2}O₁₂

| EXAMPLE No. | 4π Ms(T) | α(−35) (% · ° C.⁻¹) | α(85) (% · °+09 C.⁻¹) | ΔH(A · m⁻¹) |
|---|---|---|---|---|
| 3-1 | 0.108 | −0.08 | −0.19 | 3260 |

α(−35); Magnetization Temperature Coefficient at −35° C. to 25° C.
α(85): Magnetization Tempoerature Coefficient at 25° C. to 85° C.

TABLE 8
Y₂Gd₁F_{4.583}In_{0.1}Al_{0.2}O₁₂

| COMPARATIVE | | | | |
|---|---|---|---|---|
| EXAMPLE No. | 4π Ms(T) | α(−35) (% · ° C.⁻¹) | α(85) (% · ° C.⁻¹) | ΔH(A · m⁻¹) |
| 3-1 | 0.112 | −0.08 | −0.20 | 4140 |

α(−35): Magnetization Temperature Coefficienct at −35° C. to 25° C.
α(85): Magnetization Temperature Coefficient at 25° C. to 85° C.

The ferromagnetic resonance half-width ΔH of the sample according to Comparative Example 3-1 having indium added was 4,140 A·m⁻¹. On the other hand, the ferromagnetic resonance half-width ΔH of the sample according to Example 3-1 having indium, copper, and silicon added was 3,260 A·m⁻¹. In other words, the ferromagnetic resonance half-width ΔH was reduced in comparison with the ferromagnetic resonance half-width ΔH of the Comparative Example when the temperature coefficient a was negative in all temperature ranges.

The garnet ferrite according to the present invention has a small absolute temperature coefficient α and also has a low ferromagnetic resonance half-width ΔH. Thus, the garnet ferrite according to the present invention can be used suitably for a small-size isolator used at a high-frequency band of 500 MHz or higher. When the garnet ferrite according to the present invention is used in an isolator, the loss and the change of characteristics due to temperature can be reduced.

1. A garnet ferrite for a non-reciprocal circuit element expressed by the formula Y₃₋ₓGdₓFe_{t-2y-z}Co_{y}Si_{y}Al_{z}O₁₂, wherein 0.2≦x≦1.5, 0.005≦y≦0.015, 0≦z≦1.5, and 4.75≦t≦5.

2. A garnet ferrite for a non-reciprocal circuit element expressed by the formula Y₃₋ₓ₋ᵤGdₓCaᵤF_{t-2y-u-z}Co_{y}Si_{y}DᵤAl_{z}O₁₂, wherein D represents at least one of zirconium, hafnium, and tin, and 0.2≦x≦1.5, 0.005≦y≦0.015, 0≦z≦1.5, 4.75≦t≦5, and 0≦u≦0.3.

3. A garnet ferrite for a non-reciprocal circuit element expressed by the formula Y₃₋ₓGdₓCaᵤFe_{t-2y-v-z}Co_{y}Si_{y}Al_{z}O₁₂, wherein 0.2≦x≦1.5, 0.005≦y≦0.015, 0≦z≦1.5, 4.75≦t≦5, and 0≦v≦0.2.

4. The garnet ferrite according to claim 1, wherein 0.2≦x≦1.25, 0.005≦y≦0.01, 0≦z≦1.5, and 4.75≦t≦4.9, respectively.

5. The garnet ferrite according to claim 2, wherein 0.2≦x≦1.25, 0.005≦y≦0.01, 0≦z≦1.5, 4.75≦t≦4.9, and 0.04≦u≦0.2, respectively.

6. The garnet ferrite according to claim 3, wherein 0.2≦x≦1.25, 0.005≦y≦0.01, 0≦z≦1.5, 4.75≦t≦4.9, and 0.04≦v≦0.2, respectively.

7. A non-reciprocal circuit element comprising:
a magnetic assembly comprising:
a main body comprising a garnet ferrite according to claim 1; and
a plurality of center conductors disposed on the main body so that the center conductors intersect each other while being electrically insulated from each other.

8. A non-reciprocal circuit element comprising:
a magnetic assembly comprising:
a main body comprising a garnet ferrite according to claim 2; and
a plurality of center conductors disposed on the main body so that the center conductors intersect each other while being electrically insulated from each other.

9. A non-reciprocal circuit element comprising:
a magnetic assembly comprising:
a main body comprising a garnet ferrite according to claim 3; and
a plurality of center conductors disposed on the main body so that the center conductors intersect each other while being electrically insulated from each other.

10. A non-reciprocal circuit element having a low loss, comprising:
a magnetic assembly comprising:
a main body comprising a garnet ferrite according to claim 1;
a plurality of center conductors disposed on the upper surface of the main body so that the center conductors intersect each other at a predetermined angle while being electrically insulated from each other;
a magnet for applying a direct current magnetic field to the magnetic assembly;
matching capacitors; and
a yoke for containing the magnetic assembly, the magnet, and the matching capacitors.

11. A non-reciprocal circuit element having a low loss, comprising:
a magnetic assembly comprising:
a main body comprising a garnet ferrite according to claim 2;
a plurality of center conductors disposed on the upper surface of the main body so that the center conductors intersect each other at a predetermined angle while being electrically insulated from each other;
a magnet for applying a direct current magnetic field to the magnetic assembly;
matching capacitors; and
a yoke for containing the magnetic assembly, the magnet, and the matching capacitors.

12. A non-reciprocal circuit element having a low loss, comprising:
a magnetic assembly comprising:
a main body comprising a garnet ferrite according to claim 3;
a plurality of center conductors disposed on the upper surface of the main body so that the center conductors intersect each other at a predetermined angle while being electrically insulated from each other;
a magnet for applying a direct current magnetic field to the magnetic assembly;
matching capacitors; and
a yoke for containing the magnetic assembly, the magnet, and the matching capacitors.
